(19) United States
(12) Patent Application Publication
(10) Pub. No.: US 2022/0243506 A1
(43) Pub. Date: Aug. 4, 2022

(54) DOOR HANDLE STRUCTURE OF VEHICLE

(71) Applicant: MAZDA MOTOR CORPORATION, Hiroshima (JP)

(72) Inventors: Yukihiro MORIYAMA, Aki-gun (JP); Eisuke KURAMOTO, Aki-gun (JP)

(73) Assignee: MAZDA MOTOR CORPORATION, Hiroshima (JP)

(21) Appl. No.: 17/501,628

(22) Filed: Oct. 14, 2021

(30) Foreign Application Priority Data
Feb. 3, 2021 (JP) 2021-015642

(51) Int. Cl. E05B 85/10; B60J 5/04; E05B 85/16

(52) U.S. Cl. CPC E05B 85/107; E05B 85/16; B60J 5/0468

(57) ABSTRACT

There are provided a hinge arm with a lever and a driving unit to transmit a drive force to the hinge arm. The lever is configured to be rotatable among a storage position where the lever is flush with a door panel, a gripping position where a whole part of a design surface of the lever is projected from the door panel by the driving unit so that a user is able to grip the lever, and an open position where the lever is further projected from the gripping position. The lever is attached to the hinge arm in a swingable manner such that at least a part of the lever is projected from the door panel by pushing one end of the lever when the lever takes the storage position.

### BACKGROUND OF THE INVENTION

The present invention relates to a door handle structure of a vehicle, in which a door handle lever and a door outer panel are configured to be flush with each other when the door handle lever is stored.

Conventionally, as disclosed in Japanese Patent Laid-Open Publication No. 2020-94455 (US Patent Application Publication No. 2020/0190848 A1), a structure in which a door handle lever (door outer handle) having a flush surface structure is a seesaw type where the door handle lever is electrically rotatable around a rotational axis provided at a bracket is known.

The above-described seesaw type has a problem in that a space where a finger of a user can be inserted is so small because a one-end side of the rotational axis is only rotated that the operability of the door handle lever (so-called lever) may be deteriorated.

Meanwhile, as disclosed in US Patent Application Publication No. 2003/0019261 A1, another structure in which a whole part of a door handle lever is configured to be projected outwardly from a door outer panel in order to improve the operability of the door handle lever is known as well. In this structure, however, it is necessary to form a recessed groove at the door outer panel because the door handle lever is required to be drawn out by using this recessed groove in a case where a motor to drive the door handle lever has broken down, so that there occurs another problem in that the appearance may be deteriorated by this recessed groove.

### SUMMARY OF THE INVENTION

Accordingly, an object of the present invention is to provide a door handle structure of a vehicle which can properly operate the door handle even in the malfunction of a driving unit, without deteriorating the appearance by forming the above-described recessed groove at the door outer panel.

The present invention is a door handle structure of a vehicle, comprising a hinge arm with a lever which is retractable from a door panel, and a driving unit to transmit a drive force to the hinge arm so as to project the lever from the door panel, wherein the lever is configured to be rotatable among a storage position where the lever is flush with the door panel, a gripping position where a whole part of a design surface of the lever is projected from the door panel by the driving unit so that a user is able to grip the lever, and an open position where the lever is further projected from the gripping position, and the lever is attached to the hinge arm in a swingable manner such that at least a part of the lever is projected from the door panel by pushing one end of the lever when the lever takes the storage position.

According to the present invention, since at least part of the lever is projected from the door panel by pushing the one end of the lever even when the lever takes the storage position, the operability of the lever is improved, and since the lever swings relative to the hinge arm even in a case where the driving unit has broken down, the lever can be gripped. Further, since the door handle can be operated without forming the recessed groove at the door panel, the flush surface structure can be provided.

Moreover, since the whole part of the design surface of the lever is so projected from the door panel when the lever takes the storage position that the user can grip the lever, a space where a finger of a user can be inserted when the lever is rotated to the gripping position can be made properly large, so that the operability of the lever is superior.

In an embodiment of the present invention, the hinge arm has the lever at one end thereof and a rotational support axis around which the lever is rotated and projected from the door panel, and the driving unit is configured to transmit the drive force to the other end of the hinge arm.

According to this embodiment, by driving the driving unit provided at the other-end side of the hinge arm, the hinge arm is rotated around the rotational support axis of the hinge arm, so that the lever at the one end of the hinge arm is projected from the door panel. Thus, the whole part of the design surface of the lever can be projected from the door panel with a simple structure.

In another embodiment of the present invention, there is provided a bracket which is fixed to the door panel so as to store the lever, wherein the hinge arm has a lever support portion which is provided inside the lever, and the lever has a protrusion portion which contacts the bracket and functions as a fulcrum in a swinging action of the lever.

According to this embodiment, since the lever swings with the fulcrum of the protrusion portion which contacts the bracket when a pushing force acting in a direction perpendicular to the door panel is inputted to the one end of the lever, the lever is caused to swing relative to the lever support portion, so that the lever is projected from the door panel so that the other end of the lever can be gripped. Accordingly, this embodiment is superior especially in a case where the driving unit has broken down. Further, since the lever can be made to swing without needing any support axis of the lever, the design property is not deteriorated even when the lever is projected from the door panel.

In another embodiment of the present invention, the hinge arm has a lever support portion which is arranged inside the lever, the lever is configured to swingable, relative to the lever support portion, around a support axis extending in a direction perpendicular to a longitudinal direction of the lever, and the lever has a cover portion which covers over an end portion of the support axis. Herein, the above-described support axis may be made integrally with the lever support portion or separately from that.

According to this embodiment, since the lever is swingable relative to the lever support portion by means of the support axis and the lever has the cover portion covering over the end portion of the support axis, the support axis of the lever is not viewed from the outside even when the lever is projected from the door panel, so that the design property is not deteriorated.

In another embodiment of the present invention, the lever support portion has a biasing mechanism to generate a resistance force against the lever moving in a swing direction relative to the lever support portion.

According to this embodiment, even if the lever is configured to be swingable relative to the lever support portion, the lever does not become loose and faulty in a normal use, thereby maintaining the operability of the lever.

The other useful embodiments of the present invention will become apparent from the following description which refers to the accompanying drawings.

### BRIEF DESCRIPTION OF THE DRAWINGS

FIG. 1 is a side view of a vehicle which has a door handle structure of the present invention.

FIG. 2 is a major-part enlarged side view of FIG. 1.

FIG. 3 is an inner side view showing an arrangement structure of a reinforcement.

FIG. 4 is a sectional view taken along line A-A of FIG. 1, which shows a storage position of a lever.

FIG. 5 is a perspective view of the lever and a hinge arm.

FIG. 6 is a perspective view showing a state shown in FIG. 5 where the lever is removed.

FIG. 7 is an outer side view of a bracket including the lever.

FIG. 8 is an outer side view showing an inner cover of the lever and the hinge arm.

FIG. 9 is an outer side view of the inner cover.

FIG. 10 is a sectional view taken along line B-B of FIG. 7.

FIG. 11 is a plan view showing a driving unit.

FIG. 12 is a plan view showing a gripping position of the lever.

FIG. 13 is a plan view showing an open position of the lever.

FIG. 14 is a plan view showing a pushing position of a switch by using an imaginary line.

FIG. 15 is a plan view showing a pushing position of a front end of the lever in an emergency by using an imaginary line.

FIG. 16 is an exploded perspective view showing another embodiment of the door handle structure of the vehicle.

FIG. 17 is a perspective view of an outer cover of the lever, when viewed from an inward side, in a vehicle width direction, of the lever.

FIG. 18 is an outer side view of the door handle structure shown in FIG. 16 in a state where the outer cover is removed.

FIG. 19 is an exploded perspective view showing further another embodiment of the door handle structure of the vehicle.

FIG. 20 is a sectional view of the door handle structure shown in FIG. 19.

### DETAILED DESCRIPTION OF THE INVENTION

### Embodiment 1

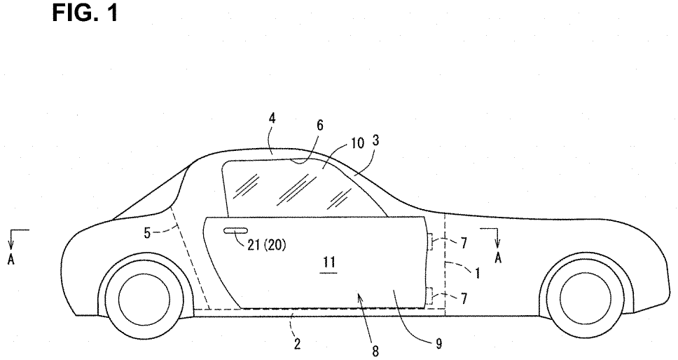

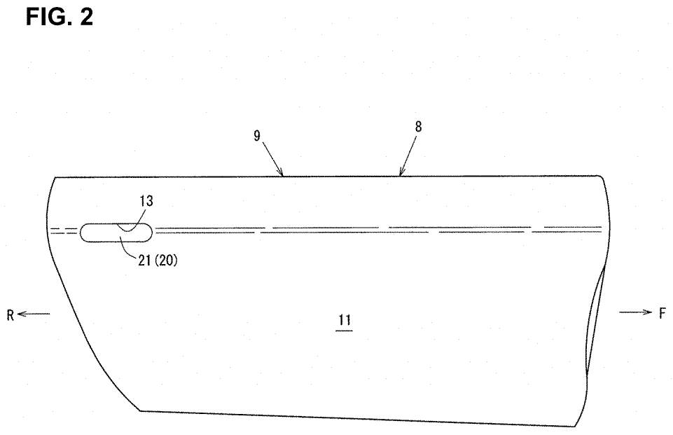

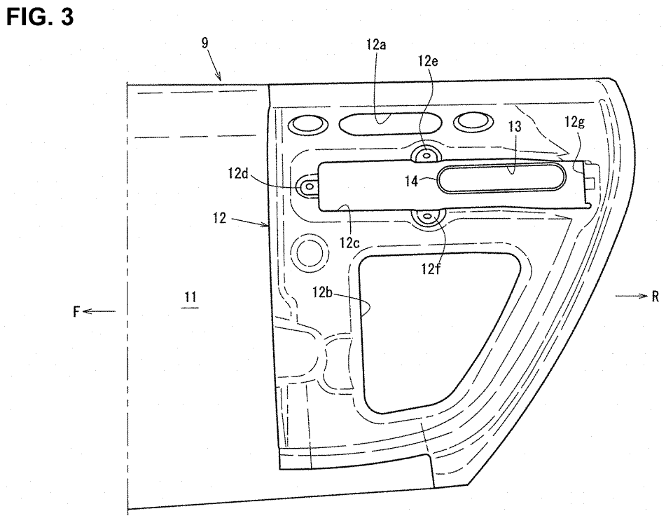

The first embodiment of the present invention will be described specifically referring to the drawings. The drawings show a door handle structure of the vehicle, and FIG. 1 is a side view of a vehicle which has the present door handle structure, FIG. 2 is a major-part enlarged side view of FIG. 1, and FIG. 3 is an inner side view showing an arrangement structure of a reinforcement.

In the figures, an arrow F shows a vehicle forward side, an arrow R show a vehicle rearward side, an arrow UP shows a vehicle upward side, and an arrow OUT shows an outward side, in a vehicle width direction. While the door handle structure of the vehicle of the present invention is applicable to a front door, a rear door, a lift gate or the like of a four-door type of vehicle, an application structure to a door of a two-door type of vehicle will be described specifically in the following embodiments.

As shown in FIG. 1, the vehicle comprises a hinge pillar 1 which extends in a vertical direction at a front portion of a cabin, a side sill 2 which extends in a vehicle longitudinal direction at a vehicle lower portion, a front pillar 3 which extends obliquely rearwardly-and-upwardly from an upper end of the hinge pillar 1, a roof side rail 4 which rearwardly extends continuously from a rear end of the front pillar 3, and a rear pillar 5 which interconnects substantially vertically the roof side rail 4 and the side sill 2.

A door opening potion 6 which is partitioned by the hinge pillar 1, the side sill 2, the front pillar 3, the roof side rail 4, and the rear pillar 5 is formed. The door opening portion 6 is closed or opened with a side door 8 which is rotatably attached to the hinge pillar 1 via a pair of upper-and-lower door hinges 7, 7.

As shown in FIGS. 1 and 2, the side door 8 comprises a door body 9 and a door window glass 10 as a door window member, and as shown in FIGS. 2 and 3, the door body 9 comprises a door outer panel 11, a door inner panel (not illustrated), and a reinforcement 12 which is provided on an inward side, in the vehicle width direction, of the door outer panel 11 and at a rear side of the door body 9.

As shown in FIG. 3, at an upper-rear side of the door outer panel 11 as the door panel are provided an opening portion 13 which stores a lever 20, which will be described later, and a flange 14 which is formed by bending an edge portion of the opening portion 13 over its entire periphery by baring processing.

Further, as shown in FIG. 3, an upper opening 12a and a lower opening 12b are respectively formed at an upper side and a lower side of the reinforcement 12, and an opening portion 12c for attaching a bracket 50, which will be described later, is formed between the both openings 12a, 12b.

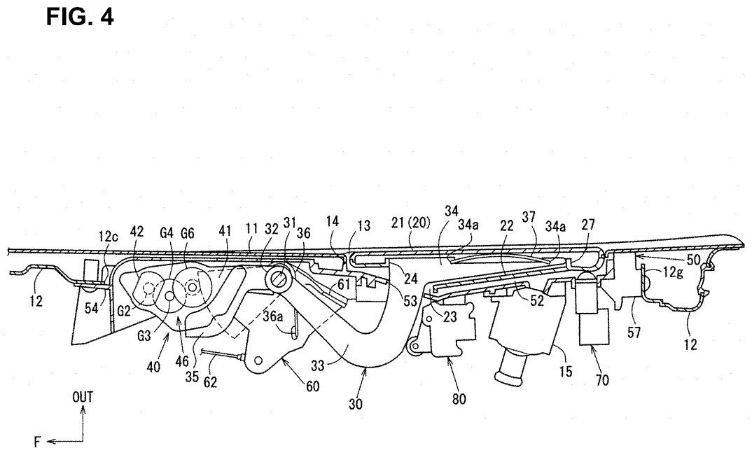

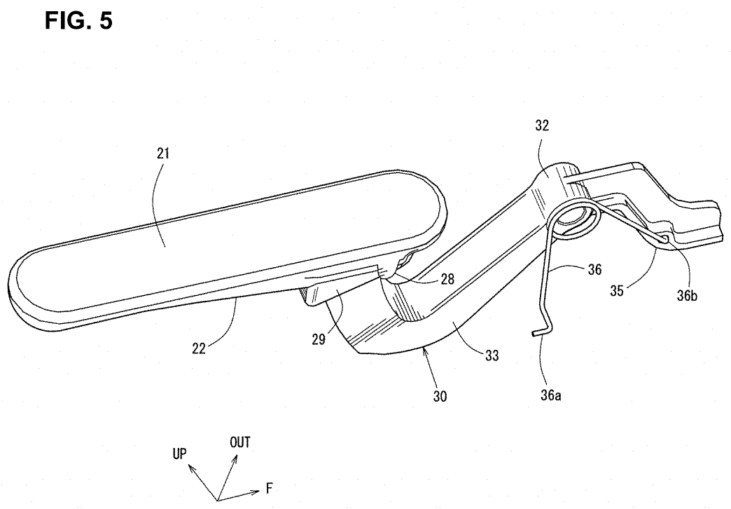

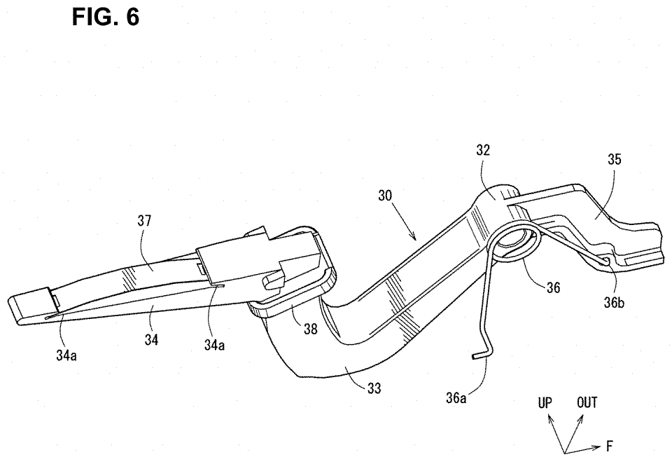

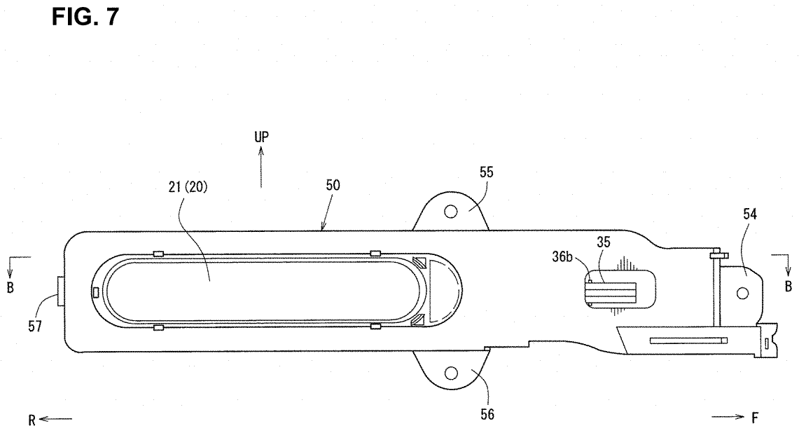

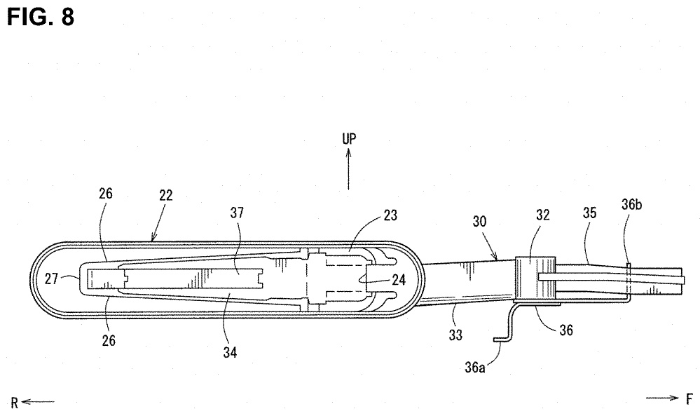

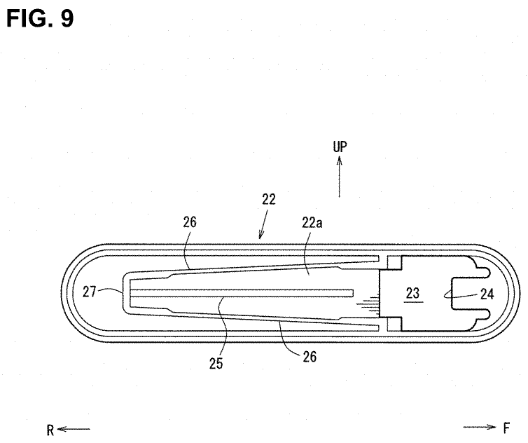

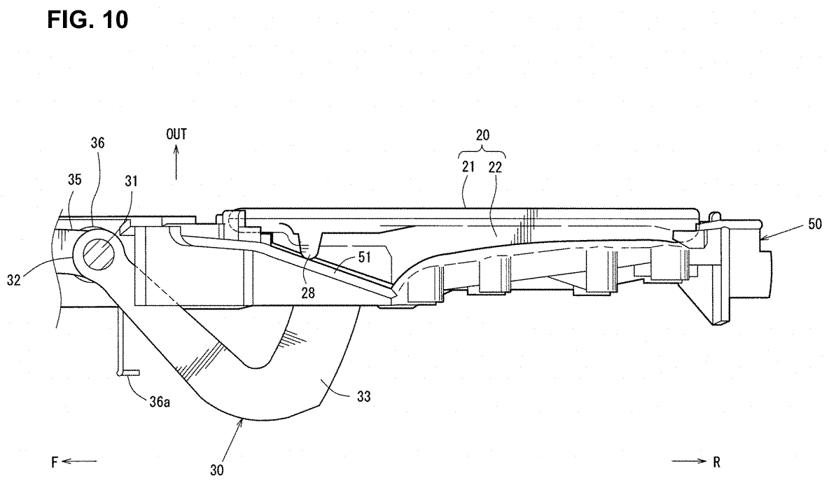

FIG. 4 is a sectional view taken along line A-A of FIG. 1, which shows a storage position of the lever, FIG. 5 is a perspective view of the lever and a hinge arm, FIG. 6 is a perspective view shows a state shown in FIG. 5 where the lever is removed, FIG. 7 is an outer side view of a bracket including the lever, FIG. 8 is an outer side view showing an inner cover of the lever and the hinge arm, FIG. 9 is an outer side view of the inner cover, and FIG. 10 is a sectional view taken along line B-B of FIG. 7.

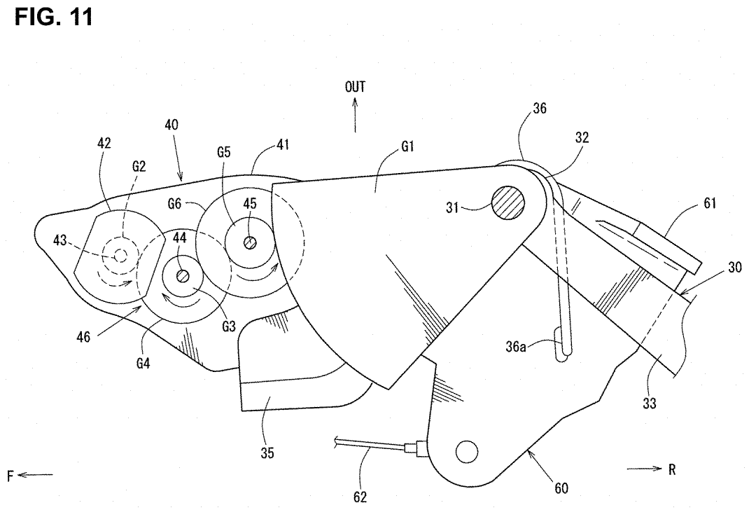

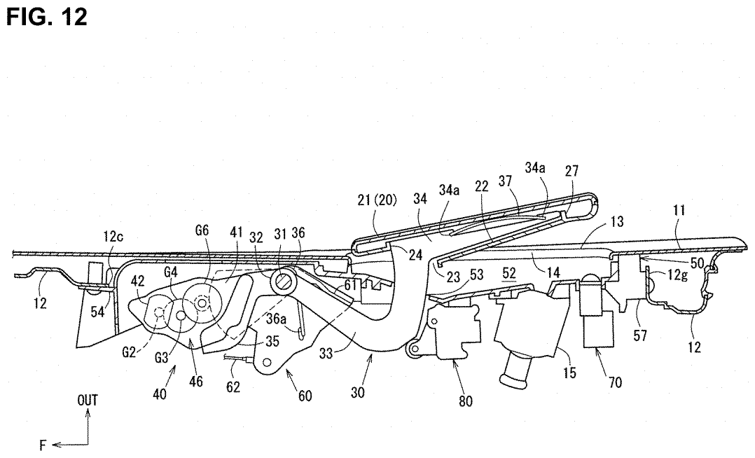

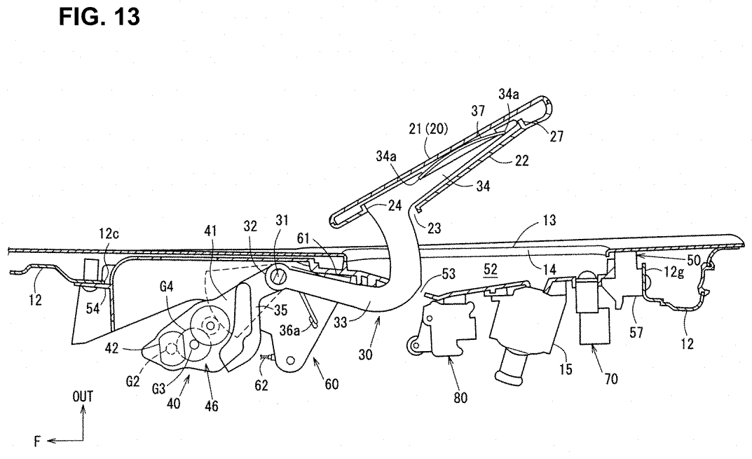

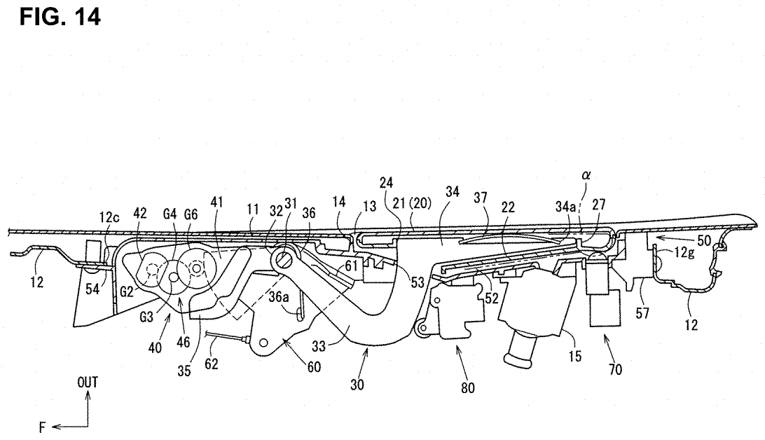

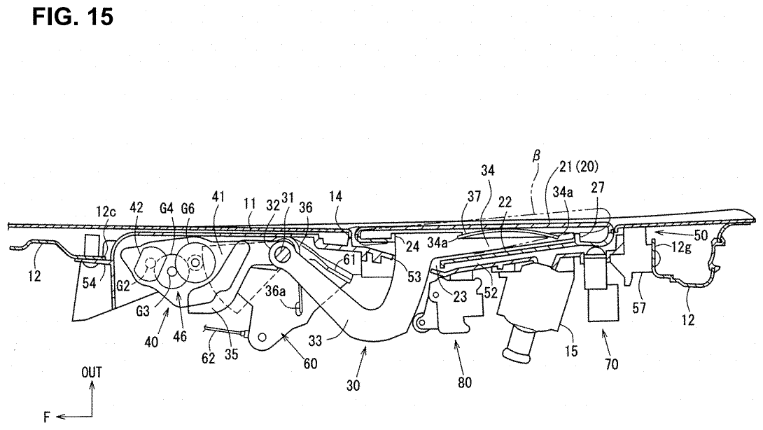

Further, FIG. 11 is a plan view showing a driving unit, FIG. 12 is a plan view showing a gripping position of the lever, FIG. 13 is a plan view showing an open position of the lever, FIG. 14 is a plan view showing a pushing position of a switch by using an imaginary line, and FIG. 15 is a plan view showing a pushing position of a front end of the lever in an emergency by using an imaginary line.

As shown in FIG. 4, the present door handle structure comprises the lever 20 (specifically, door handle lever) which is retractable from the opening portion 13 of the door outer panel 11 as the door panel, a swan-neck type of hinge arm 30 with the lever 20, and a driving unit 40 to transmit a drive force to the hinge arm 30 so as to project the lever 20 from the door outer panel 11. Further, there is provided the bracket 50 which is fixed to the reinforcement 12 as a door panel so as to store the lever 20 therein.

The lever 20 is formed by an outer cover 21 shown in FIGS. 4 and 5 and an inner cover 22 shown in FIGS. 4 and 9 which are fitted together in a convex/concave connection manner or fixedly joined together at their peripheral edge portions, and the lever 20 and the opening portion 13 of the door outer panel 11 are respectively formed in an elongated circular shape which is relatively-long in a vehicle longitudinal direction in a side view.

As shown in FIG. 9, an opening 23 where the hinge arm 30 is inserted in an assembling process is formed at a front side of the inner cover 22. A front-side wall portion 24 shown in FIGS. 4 and 9 is formed at a front edge of the opening 23.

Further, as shown in FIG. 9, a center rib 25 extending in a longitudinal direction of the inner cover 22 is formed at the center of a bottom wall 22a of the inner cover 22. Moreover, upper-and-lower side ribs 26, 26 extending in the longitudinal direction of the inner cover 22 are formed at an upper side and a lower side of the center rib 25. Also, there is provided a rear-side wall portion 27 which interconnects respective rear ends of the side ribs 26, 26 in a vertical direction. Herein, these ribs 25, 26 and the rear-side wall portion 27 are configured to protrude outwardly from the bottom wall 22a of the inner cover 22.

As shown in FIGS. 5 and 10, a protrusion portion 28 is formed at a front side of the opening 23 (see FIG. 9) where the hinge arm 30 provided outside of the inner cover 22 is inserted. This protrusion portion 28 is of a tongue-piece shape and configured to contact a facing wall 51 of the bracket 50 and function as a fulcrum in a swinging action of the lever 20.

Further, as shown in FIG. 5, a cylindrical portion 29 which is spaced apart from the hinge arm 30 and encloses the hinge arm 30 is formed at an inward side, in the vehicle width direction, of the opening 23 (see FIG. 9). As show in FIG. 4, the hinge arm 30 has the above-described lever 20 at its one end (its rear end in the present embodiment), and is provided with a hinge pin 31 as a rotational support axis around which the lever 20 is rotated in such a manner that the lever 20 is projected from the door outer panel 11. This hinge pin 31 is fixed to bracket 50 such that it extends in the vertical direction.

Moreover, as shown in FIG. 4, the hinge arm 30 comprises a pivotal portion 32 to pivotally support the hinge pin 31, a lever support portion 34 which extends rearwardly from the pivotal portion 32 via a swan-neck shaped neck portion 33, and an extension portion 35 which extends forwardly, in an opposite direction to the neck portion 33, from the pivotal portion 32 via the swan-neck shaped neck portion 33, which are formed integrally. The lever support portion 34 is arranged inside the lever 20 which is formed by the outer cover 21 and the inner cover 22.

As shown in FIG. 4, a motor base 41 for assembling the driving unit 40 is attached to the extension portion 35 of the hinge arm 30. Also, as shown in FIG. 4, a crank plate 60 is provided coaxially with the hinge pin 31. A vertical wall 61 which contacts and engages with the neck portion 33 of the hinge arm 30 when the lever 20 and the hinge arm 30 are rotated at the gripping position (see FIG. 12) is integrally formed at an rearward-and-outward side, in the vehicle width direction, of the crank plate 60.

Moreover, a release wire 62 for releasing a door latch (not illustrated) is fixed to an inward end, in the vehicle width direction, of the crank plate 60. This crank plate 60 is always biased in an anti-release direction by means of a coil spring (not illustrated) having a large spring force.

Meanwhile, a torsion spring 36 is wound around the hinge pin 31, one end 36a of the torsion spring engages with the crank plate 60 shown in FIG. 4, and the other end 36b of the torsion spring 36 engages with the extension portion 35 of the hinge arm 30 as shown in FIG. 5. Thereby, the lever 20 is always biased in its storage direction by means of the torsion spring 36. A spring force of this torsion spring 36 is set to be smaller than that of the coil spring (not illustrated) which biases the crank plate 60 in the anti-release direction.

As shown in FIGS. 4 and 6, the lever support portion 34 has a plate spring 37 as a biasing mechanism to generate a resistance force against the lever moving in a swing direction relative to the lever support portion 34 of the lever 20. That is, a pair of engagement recessed portions 34a, 34a with which the plate spring 37 engages are formed at a side of the lever support portion 34 which faces the outer cover 21, and the plate spring 37 is arranged between these engagement recessed portions 34a, 34a such that it protrudes outwardly. An outward end, in the vehicle width direction, of the plate spring 37 contacts the outer cover 21.

Thereby, even if the lever 20 swings relative to the lever support portion 34, the lever 20 does not become loose and faulty in a normal use, thereby maintaining the operability of the lever 20.

Next, a structure of the driving unit 40 to transmit the drive force to the other side (see the extension portion 35) of the hinge arm 30 will be described referring to FIG. 11. While its illustration is omitted in FIGS. 4 and 12-15, the driving unit 40 has a sector gear G1 which is fixed coaxially with the hinge pin 31. The hinge pin 31 is fitted into this sector gear G1, and the sector gear G1 is attached to the above-described bracket 50 so as not to change its position.

A motor 42 is attached to the motor base 41. A rotational axis 43 of the motor 42 is fitted into an output gear G2. An idle gear G4 having a pinion gear G3 is provided at an axis 44 which is provided at the motor base 41. Further, a driven gear G6 having a pinion gear G5 is provided at another axis 45 which is provided at the motor base 41.

As shown in FIG. 11, the output gear G2 engages with the idle gear G4. The pinion gear G3 engages with the driven gear G6. The pinion gear G5 engages with the sector gear G1. Thereby, when the motor 42 is driven and the rotational axis 43 and the output gear G2 are rotated in a counterclockwise direction in FIG. 11, the pinion gear G5 is finally rotated in the counterclockwise direction in FIG. 11 through respective rotations of the gears G2, G4, G3, G6.

As the pinion gear G5 is rotated in the counterclockwise direction in FIG. 11, a gear train 46 comprising the gears G2-G6, the motor 42, and the motor base 41 move in a projection direction of the lever 20 along an arc shape of the sector gear G1 because the position of the sector gear G1 does not change, so that the lever 20 is projected via the hinge arm 30.

The above-described lever 20 is configured to be rotatable among the storage position (see FIG. 4) where the outer cover 21 of the lever 20 is flush with the door outer panel 11, the gripping position (see FIG. 12) where a whole part of a design surface of the lever 20 is projected from the door outer panel 11 by the driving unit 40 so that a user is able to grip the lever 20, and the open position (see FIG. 13) where the lever 20 is further projected from the gripping position.

The lever 20 can be rotated by the driving unit 40 between the storage position shown in FIG. 4 and the gripping position shown in FIG. 12. Further, while the hinge arm 30 moves from the storage position shown in FIG. 4 to the gripping position shown in FIG. 12, the crank plate 60 is biased in the anti-release direction by the coil spring having the strong spring force, not moving.

In the gripping position shown in FIG. 12, the lever 20 is projected outwardly from the door outer panel 11 so that the user can grip the lever 20, so that the lever 20 can be moved by the user from the gripping position shown in FIG. 12 to the open position shown in FIG. 13.

When the hinge arm 30 reaches the gripping position as shown in FIG. 12, the neck portion 33 of the hinge arm 30 contacts the vertical wall 61 of the crank plate 60. Accordingly, as the lever is rotated in an open direction of the lever 20 against the spring force of the coil spring, not illustrated, the crank plate 60 is moved in a release direction, thereby releasing the door latch via the release wire 62.

Herein, as shown in FIG. 4, the bracket 50 has a storage space 52 of the lever 20 which is inserted into the opening portion 13 and an insertion hole 53 of the hinge arm 30. Further, as shown in FIG. 7, the bracket 50 comprises a front-side attachment portion 54, an upper-side attachment portion 55, a lower-side attachment portion 56, and a rear-side attachment portion 57.

As shown in FIGS. 7 and 3, the front-side attachment portion 54 of the bracket 50 is fixedly fastened to a front-side attachment base 12d provided at a peripheral edge of the opening portion 12c of the reinforcement 12. Likewise, the upper-side and lower-side attachment portions 55, 56 are fixedly fastened to an upper-side attachment base 12e and a lower-side attachment base 12f which are provided at the peripheral edge of the opening portion 12c of the reinforcement 12.

As shown in FIGS. 3 and 4, an erected portion 12g which extends outwardly is integrally formed at a rear-side periphery of the opening portion 12c of the reinforcement 12, and the rear-side attachment portion 57 of the bracket 50 which is shown in FIG. 7 is fixedly fastened to the erected portion 12g.

Meanwhile, as shown in FIG. 4, a switch 70 is arranged at an inward side, in the vehicle width direction, of a rear-end side of the bracket 50 which faces a rear end portion of the lever 20, specifically, a rear end portion of the inner cover 22. This switch 70 is configured to be turned ON when being pushed by operation, thereby feeding the electricity to the motor 42.

Further, a key cylinder 15 is arranged at the bracket 50 which is forwardly close to the switch 70. As shown in FIG. 4, in the storage position of the lever 20, a temporary holding mechanism 80 to temporarily hold the hinge arm 30 at the gripping position shown in FIG. 12 is arranged at a specified position of the bracket 50 between the neck portion 33 of the hinge arm 30 and the key cylinder 15.

As shown in FIG. 14, since the lever 20 is configured to be swingable relative to the lever support portion 34 of the hinge arm 30, when the rear end portion of the lever 20 positioned in the storage position is pushed from an outward side, the rear end portion of the lever 20 is moved so as to swing inwardly, in the vehicle width direction, as shown by an imaginary line α in FIG. 4, so that a switch pushing position where the switch 70 is turned ON is taken.

As shown in FIG. 15, the lever 20 is attached to the lever support portion 34 of the hinge arm 30 in a swingable manner such that at least a part of the lever 20 (a rear side of the lever 20 in the present embodiment) is projected from the door outer panel 11 as shown by an imaginary line β by pushing the front end of the lever 20 when the lever 20 takes the storage position.

In a case where the lever 20 is moved from the storage position shown by a solid line in FIG. 15 to this front-end pushed position shown by the imaginary line β, the protrusion portion 28 shown in FIG. 10 contacts the facing wall 51 of the bracket 50, thereby making the lever 20 swing with the fulcrum of the protrusion portion 28. Accordingly, the lever 20 can swing stably relative to the lever support portion 34 and also the lever 20 is projected from the door outer panel 11 so that its rear end can be gripper properly by the user. This is especially superior when the driving unit 40 has broken down.

The protrusion portion 28 of the lever 20 becomes not only the fulcrum but a guide by contacting of the front-side wall portion 24 and the rear-side wall portion 27 of the inner cover 22 shown in FIG. 15 to the front-and-rear ends of the lever support portion 34 when the front end of the lever 20 is pushed, so that the lever 20 can swing stably relative to the lever support portion 34.

In FIG. 6, reference character 38 denotes a member to seal a gap between the lever 20 and the bracket 50, which is illustrated in FIG. 6 only just for convenience.

As described above, the door handle structure of the vehicle according to the first embodiment shown in FIGS. 1-15 comprises the hinge arm 30 with the lever 20 which is retractable from the door panel (door outer panel 11), and the driving unit 40 to transmit the drive force to the hinge arm 30 so as to project the lever 20 from the door panel (door outer panel 11), wherein the lever 20 is configured to be rotatable among the storage position (see FIG. 4) where the lever 20 is flush with the door panel (door outer panel 11), the gripping position (see FIG. 12) where the whole part of the design surface of the lever 20 is projected from the door panel (door outer panel 11) by the driving unit 40 so that the user is able to grip the lever 20, and the open position (see FIG. 13) where the lever 20 is further projected from the gripping position, and the lever 20 is attached to the hinge arm 30 in the swingable manner such that at least a part of the lever 20 is projected from the door panel (door outer panel 11) by pushing one end (the front end in the present embodiment) of the lever 20 when the lever 20 takes the storage position (see FIGS. 4, 12, 13 and 15).

According to this embodiment, since at least part of the lever 20 is projected from the door panel (door outer panel 11) by pushing the one end of the lever 20 even when the lever 20 takes the storage position, the operability of the lever 20 is improved, and since the lever 20 swings relative to the hinge arm 30 as shown by the imaginary line β even in a case where the driving unit 40 has broken down, the lever 20 can be gripped.

Further, since the door handle can be operated without forming the recessed groove (see the above-described second patent document) at the door panel (door outer panel 11), the flush surface structure can be provided.

Moreover, since the whole part of the design surface of the lever 20 is so projected from the door panel when the lever 20 takes the storage position that the user can grip the lever 20, a space where a finger of the user can be inserted when the lever 20 is rotated to the gripping position can be made properly large, so that the operability of the lever 20 is superior.

Further, in the embodiment of the present invention, the hinge arm 30 has the lever 20 at its one end (its rear end in the embodiment) and the rotational support axis (hinge pin 31) around which the lever 20 is rotated and projected from the door panel (door outer panel 11), and the driving unit 40 is configured to transmit the drive force to the other end (the front-end side in the embodiment) of the hinge arm 30 (see FIG. 4).

According to this embodiment, by driving the driving unit 40 provided at the other-end side of the hinge arm 30, the hinge arm 30 is rotated around the rotational support axis (hinge pin 31) of the hinge arm 30, so that the lever 20 at the one end of the hinge arm 30 is projected from the door panel (door outer panel 11). Thus, the whole part of the design surface of the lever 20 can be projected from the door panel (door outer panel 11) with a simple structure.

Moreover, in the embodiment of the present invention, there is provided the bracket 50 which is fixed to the door panel (reinforcement 12) so as to store the lever 20, wherein the hinge arm 30 has the lever support portion 34 which is provided inside the lever 20, and the lever 20 has the protrusion portion 28 which contacts the bracket 50 and functions as the fulcrum in the swinging action of the lever 20 (see FIG. 10).

According to this embodiment, since the lever 20 swings with the fulcrum of the protrusion portion 28 which contacts the bracket 50 when a pushing force acting in a direction perpendicular to the door panel (door outer panel 11) is inputted to the one end (the front end in the embodiment) of the lever 20, the lever 20 is caused to swing relative to the lever support portion 34, so that the lever 20 is projected from the door panel (door outer panel 11) so that the other end (the rear end in the embodiment) of the lever 20 can be gripped. Accordingly, this embodiment is superior especially in a case where the driving unit 40 has broken down. Further, since the lever 20 can be made to swing without needing any support axis of the lever 20, the design property is not deteriorated even when the lever 20 is projected from the door panel (door outer panel 11).

Additionally, in the embodiment of the present invention, the lever support portion 34 has the biasing mechanism (see the plate spring 37) to generate the resistance force against the lever 20 moving in the swing direction relative to the lever support portion 34 (see FIGS. 4 and 6).

According to this embodiment, even if the lever 20 is configured to be swingable relative to the lever support portion 34, the lever 20 does not become loose and faulty in the normal use, thereby maintaining the operability of the lever 20.

### Embodiment 2

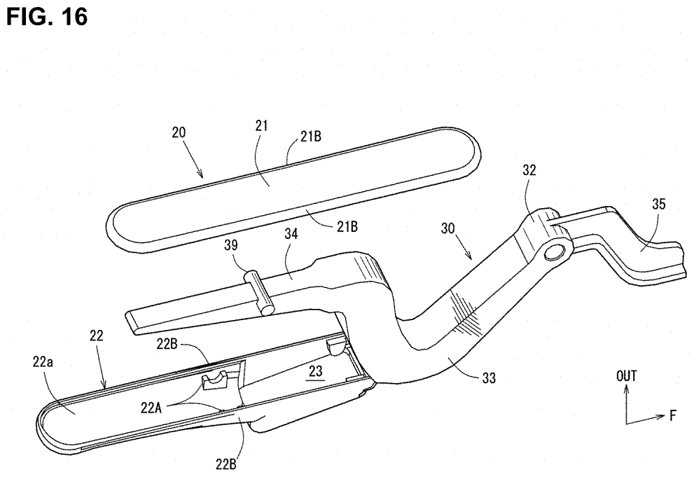

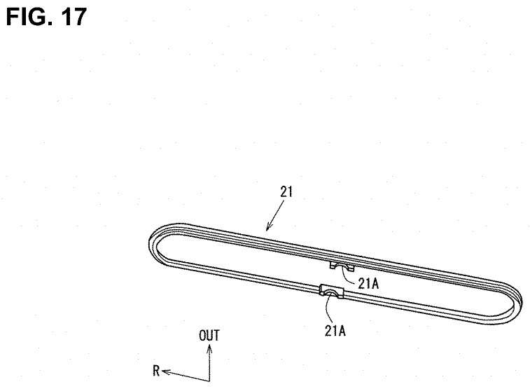

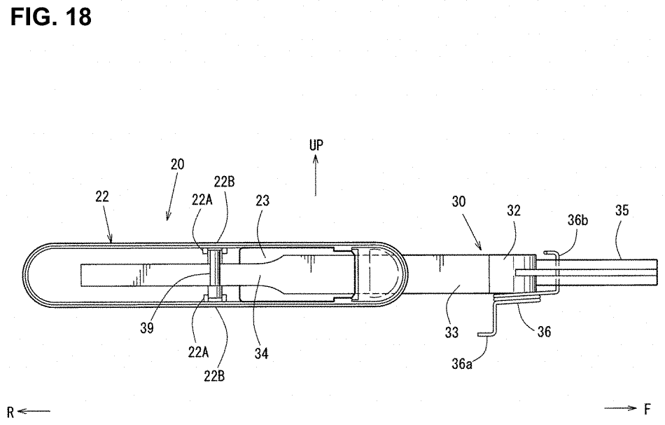

Next, the second embodiment of the door handle structure of the vehicle will be described referring to FIGS. 16, 17 and 18. FIG. 16 is an exploded perspective view showing the door handle structure, FIG. 17 is a perspective view of an outer cover of the lever, when viewed from an inward side, in the vehicle width direction, of the lever, and FIG. 18 is an outer side view of the door handle structure shown in FIG. 16 in a state where the outer cover is removed.

In the second embodiment shown in FIGS. 16-18 as well, the hinge lever 30 has the lever support portion 34 which is arranged inside the lever 20. A support axis 39 which protrudes outwardly (in the vertical direction in the embodiment) from the lever support portion 34 is integrally provided at a middle position, in the longitudinal direction, of the lever support portion 34. This support axis 39 extends in a direction perpendicular to the longitudinal direction of the lever 20 (i.e., in the vertical direction).

As shown in FIG. 17, a pair of journal portions 21A, 21A which are respectively configured to have a half-split structure and accept a protrusion portion of the support axis 39 which protrudes from the lever support portion 34 are integrally formed at the outer cover 21. Likewise, as shown in FIGS. 16 and 18, a pair of journal portions 22A, 22A which are respectively configured to have a half-split structure and accept the protrusion portion of the support axis 39 which protrudes from the lever support portion 34 in corporation with the above-described journal portions 21A, 21A are integrally formed at the inner cover 22.

When the outer cover 21 and the inner cover 22 are fitted together in the convex/concave connection manner, these journal portions 21A, 22A rotationally support the support axis 39. Thereby, the lever 20 is supported at the support axis 39 extending in the direction perpendicular to the longitudinal direction of the lever 20 (i.e., in the vertical direction) so that the lever 20 is swingable relative to the lever support portion 34.

Further, the outer cover 21 and the inner cover 22 which constitute the lever 20 respectively have cover portions 21B, 22B which cover over end portions of the support axis 39. These cover portions 21B, 22B are not made by additional parts but constituted by parts of the outer cover 21 and the inner cover 22 which face the respective end portions of the support axis 39.

As described above, in the second embodiment shown in FIGS. 16-18, the hinge arm 30 has the lever support portion 34 which is arranged inside the lever 20, the lever 20 is configured to swingable, relative to the lever support portion 34, around the support axis 39 extending in the direction perpendicular to the longitudinal direction of the lever 20, and the lever 20 has the cover portions 21B, 22B which cover over the end portions of the support axis 39 (see FIGS. 16-18).

According to this embodiment, since the lever 20 is swingable relative to the lever support portion 34 by means of the support axis 39 and the lever 20 has the cover portions 21B, 22B which cover over the end portions of the support axis 39, the support axis 39 of the lever 20 is not viewed from the outside even when the lever 20 is projected from the door panel (door outer panel 11), so that the design property is not deteriorated.

The second embodiment shown in FIGS. 16-18 have substantially the same structures, operations, and effects as the first embodiment, and therefore the same elements are denoted by the same reference characters and their specific descriptions are omitted here.

### Embodiment 3

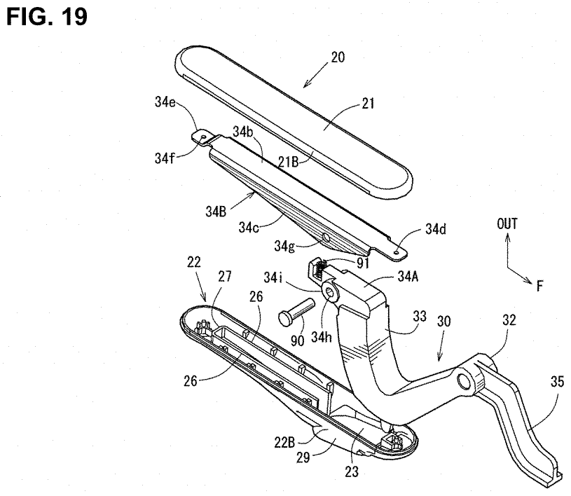

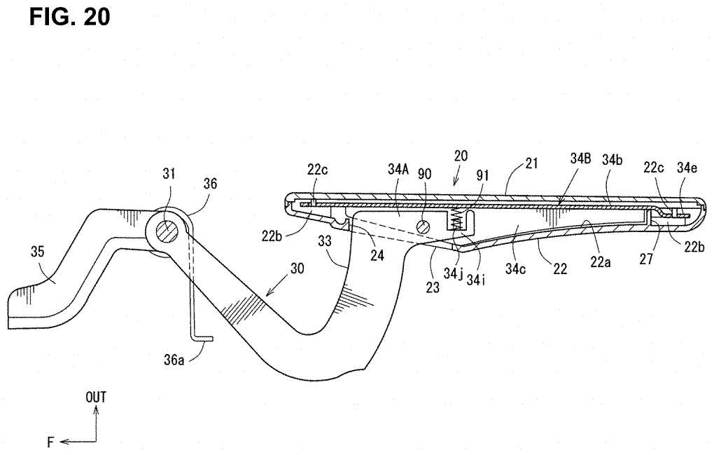

Next, the third embodiment of the door handle structure of the vehicle will be described referring to FIGS. 19 and 20. FIG. 19 is an exploded perspective view showing the third embodiment of the door handle structure of the vehicle, and FIG. 20 is a sectional view of the door handle structure shown in FIG. 19.

In the third embodiment, the hinge arm 30 is made of metal as a whole. Further, while the hinge arm 30 has the lever support portion which is arranged inside the lever 20, this lever support portion is constituted by two split parts of a fixed support portion 34A which is integrally formed at a tip of the hinge arm 30 and a movable support portion 34B which is configured to be swingable relative to the fixed support portion 34A. The movable support portion 34B is made of a metal-made reinforcing member.

The movable support portion 34B comprises an outer wall 34b, a pair of side walls 34c, 34c which extend inwardly, in the vehicle width direction, from upper-and-lower both ends of the outer wall 34b, a guide hole 34d which is formed at a front end portion of the outer wall 34b, a tongue piece 34e which is configured to step down inwardly, in the vehicle width direction, from a rear end portion of the outer wall 34b, and a guide hole 34f which is formed at the tongue piece 34e. Further, hole portions 34g where a support axis 90, which will be described later, is inserted are formed at the pair of side walls 34c, 34c of the movable support portion 34B.

Meanwhile, an insertion hole 34h where the support axis 90 is inserted is formed at the fixed support portion 34A, and a recessed portion 34i is integrally formed at a tip side (a rear-end side in the embodiment) of the fixed support portion 34A. Further, a guide pin 34j which extends outwardly, in the vehicle width direction, from a bottom portion of the recessed portion 34i is integrally formed. Herein, the above-described support axis 90 extends in a direction perpendicular to a longitudinal direction of the movable support portion 34B (i.e., in the vertical direction).

Guide pins 22c, 22c are formed at the bottom wall 22a of the inner cover 22 of the lever 20 via spacers 22b, 22b.

As shown in FIGS. 19 and 20, a front side of the movable support portion 34B is covered with the fixed support portion 34A, a position of the hole portion 34g on the side of the movable support portion 34B and a position of the insertion hole 34h on the side of the fixed support portion 34A are made to match each other, and the metal-made support axis 90 is inserted into the hole portion 34g and the insertion hole 34h. Further, as shown in FIG. 20, the guide pin 22c on the side of the inner cover 22 is inserted into the guide holes 34d, 34f of the movable support portion 34B.

Further, a coil spring 91 which is guided by the guide pin 34j is provided to extend between the recessed portion 34i of the fixed support portion 34A and the outer wall 34b of the movable support portion 34B so that a rear side of the movable support portion 34B is biased forwardly by the coil spring 91.

That is, in the third embodiment, the movable support portion 34B is configured to be swingable with the fulcrum of the support axis 90 relative to the fixed support portion 34A, whereby the lever 20 is configured to be swingable via the movable support portion 34B relative to the hinge arm 30.

Moreover, in the third embodiment, by forming the hinge arm 30 having the fixed support portion 34A, the movable support portion 34B, and the support axis 90 by a metal-made high-rigidity member, respectively, the elements 30, 34A, 34B, 90 are prevented from getting broken even if a large operational force (e.g., about 50 kg) is applied when the lever 20 is moved from the gripping position to the open position.

As described above, in the third embodiment shown in FIGS. 19 and 20 as well, the hinge arm 30 has the lever support portion (the fixed support portion 34A, the movable support portion 34B) which is arranged inside the lever 20, the lever 20 is configured to be swingable around the support axis 90 extending in the direction perpendicular to the longitudinal direction of the lever 20 relative to the lever support portion (see the fixed support portion 34A in particular), and the lever 20 has the cover portions 21B, 22B which cover over the end portions of the support axis 90.

According to this embodiment, since the lever 20 is swingable relative to the lever support portion (the fixed support portion 34A, the movable support portion 34B) by means of the support axis 90 and the lever 20 has the cover portions 21B, 22B which cover over the end portions of the support axis 90, the support axis 90 of the lever 20 is not viewed from the outside even when the lever 20 is projected from the door panel (door outer panel 11), so that the design property is not deteriorated.

The third embodiment shown in FIGS. 19 and 20 have substantially the same structures, operations, and effects as the first and second embodiments, and therefore the same elements are denoted by the same reference characters and their specific descriptions are omitted here.

In correspondence of the present invention to the above-described embodiments, the door panel of the present invention corresponds to the door outer panel 11 including the reinforcement of the embodiments. Likewise, the rotational support axis corresponds to the hinge pin 31, the lever support portion corresponds to the lever support portion 34 or the lever support portion comprising the fixed support portion 34A and the movable support portion 34B, and the biasing mechanism corresponds to the plate spring 37. However, the present invention is not limited to the above-described embodiments.

For example, while the above-described embodiments exemplify the door handle structure of the vehicle which is applied to the door of the two-door type of vehicle, this is applicable to a front door, a rear door, a lift gate, or the like of a four-door type of vehicle as well.

As described above, the present invention is useful in the door handle structure of the vehicle in which the door handle lever and the door outer panel are configured to be flush with each other.

What is claimed is:

1. A door handle structure of a vehicle, comprising:
a hinge arm with a lever which is retractable from a door panel; and
a driving unit to transmit a drive force to the hinge arm so as to project the lever from the door panel,
wherein said lever is configured to be rotatable among a storage position where the lever is flush with the door panel, a gripping position where a whole part of a design surface of the lever is projected from the door panel by said driving unit so that a user is able to grip the lever, and an open position where the lever is further projected from said gripping position, and said lever is attached to said hinge arm in a swingable manner such that at least a part of the lever is projected from the door panel by pushing one end of the lever when the lever takes the storage position.

2. The door handle structure of the vehicle of claim 1, wherein said hinge arm has said lever at one end thereof and a rotational support axis around which the lever is rotated and projected from the door panel, and said driving unit is configured to transmit the drive force to the other end of the hinge arm.

3. The door handle structure of the vehicle of claim 2, further comprising a bracket which is fixed to the door panel so as to store said lever, wherein said hinge arm has a lever support portion which is provided inside the lever, and said lever has a protrusion portion which contacts said bracket and functions as a fulcrum in a swinging action of the lever.

4. The door handle structure of the vehicle of claim 2, wherein said hinge arm has a lever support portion which is arranged inside the lever, said lever is configured to swingable, relative to said lever support portion, around a support axis extending in a direction perpendicular to a longitudinal direction of the lever, and said lever has a cover portion which covers over an end portion of said support axis.

5. The door handle structure of the vehicle of claim 4, wherein said lever support portion has a biasing mechanism to generate a resistance force against the lever moving in a swing direction relative to the lever support portion.

6. The door handle structure of the vehicle of claim 1, further comprising a bracket which is fixed to the door panel so as to store said lever, wherein said hinge arm has a lever support portion which is provided inside the lever, and said lever has a protrusion portion which contacts said bracket and functions as a fulcrum in a swinging action of the lever.

7. The door handle structure of the vehicle of claim 1, wherein said hinge arm has a lever support portion which is arranged inside the lever, said lever is configured to swingable, relative to said lever support portion, around a support axis extending in a direction perpendicular to a longitudinal direction of the lever, and said lever has a cover portion which covers over an end portion of said support axis.

8. The door handle structure of the vehicle of claim 6, wherein said lever support portion has a biasing mechanism to generate a resistance force against the lever moving in a swing direction relative to the lever support portion.

9. The door handle structure of the vehicle of claim 7, wherein said lever support portion has a biasing mechanism to generate a resistance force against the lever moving in a swing direction relative to the lever support portion.

10. The door handle structure of the vehicle of claim 3, wherein said lever is constituted by an outer cover and an inner cover, said protrusion portion is of a tongue-piece shape and configured to contact a facing wall of said bracket and function as the fulcrum in the swinging action of the lever is formed at a front side of an opening where said hinge arm provided outside of said inner cover is inserted.

11. The door handle structure of the vehicle of claim 4, wherein said lever is constituted by an outer cover and an inner cover, and said outer cover and said inner cover respectively have cover portions which cover over end portions of said support axis.

12. The door handle structure of the vehicle of claim 4, wherein said support axis which protrudes outwardly from said lever support portion is integrally provided at a middle position, in a longitudinal direction, of said lever support portion.

13. The door handle structure of the vehicle of claim 11, wherein a pair of journal portions which are respectively configured to have a half-split structure and accept a protrusion portion of said support axis which protrudes from said lever support portion are integrally formed at said outer cover, a pair of journal portions which are respectively configured to have a half-split structure and accept said protrusion portion of the support axis in corporation with said pair of journal portions provided at the outer cover are integrally formed at said inner cover.

14. The door handle structure of the vehicle of claim 3, wherein said lever support portion has a plate spring as a biasing mechanism to generate a resistance force against said lever moving in a swing direction relative to the lever support portion of the lever, a pair of engagement recessed portions with which said plate spring engages are formed at a side of the lever support portion which faces the lever, and the plate spring is arranged between said engagement recessed portions such that the plate spring protrudes outwardly.

15. The door handle structure of the vehicle of claim 1, wherein said hinge arm has a lever support portion which is arranged inside the lever, said lever support portion is constituted by a fixed support portion which is integrally formed at a tip of the hinge arm and a movable support portion which is configured to be swingable relative to said fixed support portion, said movable support portion is configured to be swingable around a support axis which is attached to said fixed support portion and extends in a direction perpendicular to a longitudinal direction of the lever relative to said fixed support portion.
